(19) United States
(12) Patent Application Publication
(10) Pub. No.: US 2023/0059818 A1
(43) Pub. Date: Feb. 23, 2023

(54) SUPER ABSORBENT POLYMER AND A PESTICIDE

(71) Applicant: UPL LTD, Mumbai (IN)

(72) Inventors: Pradip Dattatray Wagh, Mumbai (IN); Rajan Ramakant Shirsat, Mumbai (IN); Prasun Sarkar, Mumbai (IN)

(21) Appl. No.: 17/788,068

(22) PCT Filed: Dec. 22, 2020
(86) PCT No.: PCT/IB2020/062314

§ 371 Date: Jun. 22, 2022

(30) Foreign Application Priority Data
Dec. 26, 2019 (IN) 201921053997

(51) Int. Cl. B01J 20/26; B01J 20/28; C05G 3/80; C05G 5/12; B01J 20/30; A01N 47/36; A01N 25/10; A01C 1/06

(52) U.S. Cl. CPC B01J 20/264; B01J 20/267; B01J 20/2803; C05G 3/80; C05G 5/12; B01J 20/3021; B01J 20/3042; A01N 47/36; A01N 25/10; A01C 1/06

(57) ABSTRACT

The present invention relates to a stable composition comprising super absorbent polymer and a bioactive agent. The present invention also relates to a method of coating seeds with said compositions and method of controlling weeds with said compositions.

### FIELD OF INVENTION

The present invention relates to a stable composition comprising super absorbent polymer and a bioactive agent. The present invention also relates to a method of coating seeds with said composition and controlling unwanted vegetation in agriculture field.

### BACKGROUND OF INVENTION

Polymer hydrogels are materials composed of a solid polymer lattice and an interstitial aqueous phase. In particular, hydrogels capable of absorbing a quantity of water in excess of 95% of their overall weight are defined as “superabsorbent”.

With growing interest in environmental protection issues, a vast amount of interest has been focused on the development of biodegradable polymer-based superabsorbent materials, having similar properties to those of the traditional superabsorbent polyacrylics. However, the manufacturing process of super absorbent polymer leads to a lot of wastage in the form of fine powder. Since it is not in the granulated form it is not used due to its lack of commercial applicability.

Thus, there lies a continuous need to find economical and efficient ways to use the waste powder of super absorbent polymer produced during its manufacturing process.

A variety of active chemical agents have been used for growing crops and other plants so as to impart to the plants desirable effects, such as enhanced growth characteristics or enhanced resistance to pests or diseases. Example, herbicides, fungicides, insecticides, chemical hybridizing agents, auxins, and plant growth regulator. These active agents are applied to the plants or to the growing medium (soil) for the plants. These treatments can be applied prior to the emergence of the plants directly to the seeds or soil directly. Such pre-emergent applications of plant chemical agents have been found to be producing desired effects in plants. Such treatments are also advantageous as this eliminate the need for the expensive equipment required for topical application.

However, there are some drawbacks also of pre-emergent application of such chemical agents. These agents tend to react with the soil and chances of leaching increases, thus reducing the efficiency. Also, if directly applied to seeds, there lies difficulty in the bonding of the active agent with the seed.

There have been reports of attempts to treat seeds with certain active agents by coating the seeds in a water-saturated hydrogel containing the agents. Such techniques entail their own problems, primarily involved not only with the space considerations resulting from the relatively large seed coatings, but also with the difficulty in adhering the water-saturated hydrogel to the seed, in keeping the coating congealed together, in handling such gelatinous masses in place of discrete, solid seeds, with agglomeration together of coated seeds and with the undesirable effects of keeping the seeds moist (e.g., germination or spoilage), especially during storage.

U.S. Pat. No. 6,557,298B2 discloses the preparation of the wet mixture of the hydrogel and active ingredient. It mentions that wet mixture can be prepared by mixing of the active ingredient and water and Super absorbent polymer.

However, there lies a continuous need of the search of treatment techniques that maintain good transportation, storage and handling of seed and still producing acceptable active ingredients. The use of coated or controlled release pesticides are one of the ways to improve efficiency of pesticides and reduce the wastage of pesticides, thus safeguarding environment.

Also, there lies a strong need of forming innovative solution to use the powdered waste produced during the manufacturing process of super absorbent polymer.

### OBJECTS OF THE INVENTION

An object of the present invention is to solve at least the above problems and/or disadvantages and to provide at least the advantages to be described later.

An object of the present invention is to provide a composition comprising powdered or granulated super absorbent polymer and a bioactive agent.

It is an object of the present invention to provide a composition comprising powdered or granulated starch based super absorbent polymer and a bioactive agent.

It is an object of the present invention to provide a composition comprising powdered or granulated starch based super absorbent polymer and a herbicide or a fungicide or an insecticide or a bio stimulant or a fertilizer or a microbial cell or combinations thereof.

It is an object of the present invention to provide a composition of powdered or granulated starch based super absorbent polymer and a herbicide.

It is an object of the present invention to provide a formulation comprising powdered or granulated starch based super absorbent polymer and Pyrazosulfuron Ethyl (PSE).

It is an object of the present invention to provide a formulation comprising powdered or granulated polymer starch-g-poly (2-propenamide-co-2-propenoic acid) potassium salt or crosslinked polyacrylic acid potassium salt and Pyrazosulfuron Ethyl (PSE).

It is an object of the present invention to provide a process for preparing a composition comprising powdered or granulated starch based super absorbent polymer and a bioactive agent.

It is another object of the present invention to provide a process for preparing a formulation comprising powdered or granulated starch based super absorbent polymer and a herbicide.

It is another object of the present invention to provide a process for preparing a formulation comprising powdered or granulated starch based super absorbent polymer and Pyrazosulfuron Ethyl (PSE).

It is another object of the present invention to provide a method for treating a seed with a formulation comprising powdered or granulated super absorbent polymer and a bioactive agent.

It is another object of the present invention to provide a method for improving delivery of a bioactive ingredient to a plant grown from a seed.

It is another object of the present invention to provide a method for improving delivery of a bioactive ingredient to pre-emergent paddy plant or seeds.

It is another object of the present invention to provide a method for controlling/inhibiting the growth of weeds in the paddy fields.

### BRIEF DESCRIPTION OF FIGURES

FIG. 1: Method of manufacturing of formulation with super absorbent polymer of the size 100 plus Mesh granules

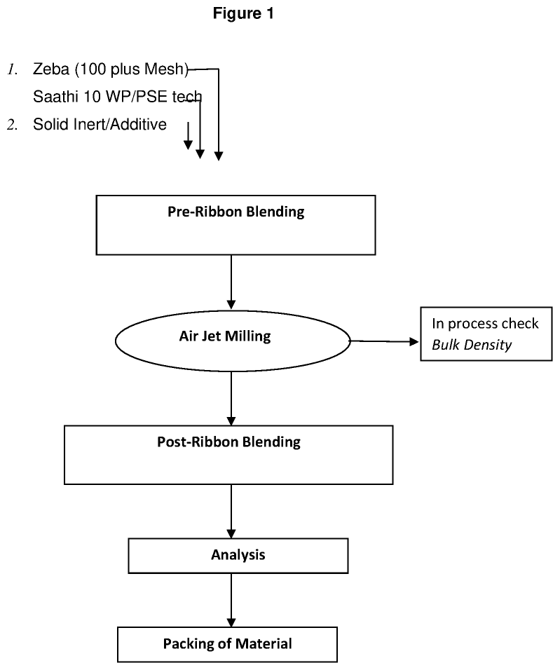

FIG. 2: Method of manufacturing of formulation of super absorbent polymer of the size 1-20 Mesh granules

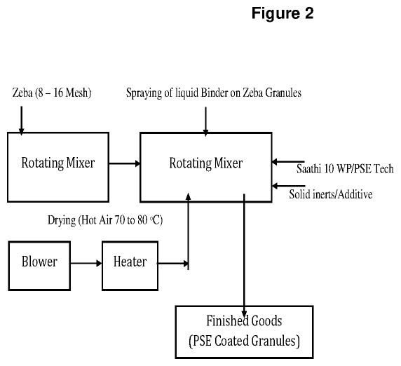

### SUMMARY OF THE INVENTION

In an aspect the present invention provides a composition comprising super absorbent polymer and a bioactive agent.

In another aspect the present invention provides a solid composition comprising super absorbent polymer and a bioactive agent.

It is another aspect of the present invention to provide a formulation comprising powdered or granulated starch based super absorbent polymer and a bioactive agent.

It is another aspect of the present invention to provide a formulation comprising powdered or granulated starch based super absorbent polymer and a herbicide or a fungicide or an insecticide or a bio stimulant or a fertilizer or a microbial cell or combinations thereof.

It is an aspect of the present invention to provide a formulation comprising powdered or granulated starch based super absorbent polymer and a herbicide.

It is another aspect of the present invention to provide a formulation comprising powdered or granulated starch based super absorbent polymer and Pyrazosulfuron Ethyl (PSE).

It is another aspect of the present invention to provide a formulation comprising powdered or granulated polymer of starch-g-poly (2-propenamide-co-2-propenoic acid) potassium salt or crosslinked polyacrylic acid potassium salt and Pyrazosulfuron Ethyl (PSE).

It is another aspect of the present invention to provide a method of preparing a formulation comprising powdered or granulated starch based super absorbent polymer and a bioactive agent.

It is another aspect of the present invention to provide a method of preparing a formulation comprising powdered or granulated starch based super absorbent polymer and a herbicide.

It is another aspect of the present invention to provide a method of preparing a formulation comprising powdered or granulated starch based super absorbent polymer and Pyrazosulfuron Ethyl (PSE).

It is another aspect of the present invention to provide a method for treating a seed with a formulation comprising powdered or granulated super absorbent polymer and a bioactive agent.

It is another aspect of the present invention to provide a method for improving delivery of an bioactive ingredient to a plant grown from a seed.

It is another aspect of the present invention to provide a method for improving delivery of a bioactive ingredient to pre-emergent paddy plants or seeds.

It is another aspect of the present invention to provide a method for inhibiting/controlling the growth of weeds in the paddy fields.

Among the several advantages of this invention, may be noted that this helps in getting an economical advantage of the powder waste produced during the manufacturing process of super absorbent polymer. Also, the granulated formulation produced comprising powdered super absorbent polymer and a bioactive agent reduces the chances of leaching of bioactive agent in soil and thus enhancing its activity which in turn helps in improving the sustainability of the environment.

### DETAILED DESCRIPTION OF THE INVENTION

For convenience, before further description of the present disclosure, certain terms employed in the specification, and examples are collected here. These definitions should be read in the light of the remainder of the disclosure and understood as by a person of skill in the art. The terms used herein have the meanings recognized and known to those of skill in the art. However, for convenience and completeness, particular terms and their meanings are set forth below.

As used herein the term ‘plant’ refers to an agricultural plant for example wheat, rye, barley, rice, triticale, oats, sorghum, sugarcane, beet, sugar beet or fodder beet, fruits like pomes, apples, pears, plums, peaches, almonds, cherries, strawberries, raspberries, blackberries or gooseberries, leguminous plants, such as lentils, peas, alfalfa or soybeans, oil plants, such as rape, oil-seed rape, canola, juncea, linseed, mustard, olives, sunflowers, coconut, cocoa beans, castor oil plants, oil palms, ground nuts or soybeans, cucurbits, such as squashes, cucumber or melons, fiber plants, such as cotton, flax, hemp or jute, citrus fruit, such as oranges, lemons, grapefruits or mandarins, vegetables, such as spinach, lettuce, asparagus, cabbages, carrots, onions, tomatoes, cucurbits or paprika, lauraceous plants, such as avocados, cinnamon or camphor, energy and raw material plants, such as corn, soybean, rape, canola, oil palm, corn, tobacco, nuts, coffee, tea, bananas, vines, hop, turf, natural rubber plants or ornamental and forestry plants, such as flowers and shrubs.

As used herein the term ‘water retention agent’ refers to an agent that has the capacity to hold water and release it as and when needed by the plant.

The terms “superabsorbent polymer” or “SAP” referred herein refer to the water swellable polymers which can absorb water many times their weight in an aqueous solution. Without wishing to be bound by theory, the term superabsorbent polymer also apply to polymer that absorb water as well as de-sorb the absorbed water. The superabsorbent polymer may be selected from but not limited to water-swellable or water absorbing or water-retentive polymers such as cross-linked polymers that swell without dissolving in the presence of water, and may, absorb at least 10, 100, 1000, or more times their weight in water.

The term “cultivation” as used herein refers to an activity to grow plants in any stage from the seeding stage to maturation stage. It means to artificially grow plants over the entire or in partial period from the seeding stage to the maturation stage and in each following stage or in stages by the combination of two or more of the stages such as (1) from nursery stage to maturation stage; (2) from nursery plants to maturation stage; (3) from seeds to nursery plants; (4) from the stage between before the desired maturation to the desired maturation and (5) from the nursery plants to the stage before the desired maturation.

Maturation stage includes the maturation stage in which the desired plant bodies or one of parts of fruits, flowers, leaves, buds, branches, stems, roots and bulbs of the plant bodies are at least made available to be harvested, or in which seeds or nursery plants are made available to be harvested from the plant bodies. Typically, the method of the present invention may be applied to other known varieties/species of plants.

Surprisingly the present inventors found an economical way to convert the powder waste generated during the manufacturing process of super absorbent polymer into a granulated formulation comprising a bioactive agent. It was further also found that the invented formulation may be used effectively as pre-emergent or seed-coating formulation, with enhanced impact of the bioactive agent.

Advantageously the present formulation ensures higher germination of paddy seeds and a faster growth as well as prevents a germination of weed seeds around the paddy seed. There is no phytotoxicity observed with present formulation.

In an aspect the present invention provides granulated or free flowable powdered composition comprising powdered or granulated superabsorbent polymer and a bioactive agent.

The superabsorbent polymer may be selected from synthetic, semi-synthetic, natural origin, degradable, non-degradable or hybrid.

In an embodiment, the superabsorbent polymer may be a selected from, but not limited to, copolymer of acrylamide and sodium acrylate; hydrolyzed starch-polyacrylonitrile; 2-propenenitrile homopolymer, hydrolyzed, sodium salt or poly(acrylamide co-sodium acrylate) or poly(2-propenamide-co-2-propanoic acid, sodium salt); starch-g-poly(2propenamide-co-2-propanoic acid, mixed sodium and aluminum salts); starch-g-poly(2-propenamide-co-2-propanoic acid, potassium salt); poly(2-propenamide-co-2-propanoic acid, sodium salt); poly-2-propanoic acid, sodium salt; starch-gpoly(acrylonitrile) or poly(2-propenamide-co-sodium acrylate); starch/acrylonitrile copolymer; crosslinked copolymers of acrylamide and sodium acrylate; acrylamide/sodium polyacrylate crosslinked polymers; anionic polyacrylamide; starch grafted sodium polyacrylates; acrylic acid polymers, sodium salt; crosslinked potassium polyacrylate/polyacrylamide copolymers; sodium polyacrylate; superabsorbent polymer laminates and composites; partial sodium salt of crosslinked polypropenoic acid; potassium polyacrylate, lightly crosslinked; sodium polyacrylate, lightly crosslinked; sodium polyacrylates; poly(sodiumacrylate) homopolymer; polyacrylamide polymers, carrageenan, agar, alginic acid, guar gums and its derivatives, and gellan gum; Specific superabsorbent polymers include crosslinked copolymer of acrylamide and potassium acrylate.

In a preferred embodiment, the superabsorbent polymer is starch-g-poly (2-propenamide-co-2-propenoic acid) potassium salt or crosslinked polyacrylic acid potassium salt.

In an embodiment, the super absorbent polymer is starch based super absorbent polymer.

In one embodiment, the superabsorbent polymer is Zeba™.

It is an aspect of the present invention that the composition comprises powdered or granulated starch based super absorbent polymer and a bioactive agent.

In an embodiment, the bioactive is selected from fertilizers, mycorrhiza, micronutrients, acaricides, algicides, antifeedants, avicides, bactericides, bird repellents, chemosterilants, fungicides, herbicide safeners, herbicides, insect attractants, insect repellents, insecticides, mammal repellents, mating disruptors, molluscicides, nematicides, plant activators, plant-growth regulators, rodenticides, synergists, virucides, derivatives thereof, biological control agents and mixtures thereof.

In preferred embodiment, the present invention provides a composition comprising at least one superabsorbent polymer and at least one fertilizer.

In an embodiment, the fertilizer is selected from organic and inorganic fertilizers such as those selected from but not limited to urea, NPK, nitrogen based fertilizers, phosphate, calcium, potassium, magnesium, sulfur, copper, iron, manganese, molybdenum, zinc, nickel, cobalt, boron and their salts and derivatives. Exemplary organic fertilizer may be selected from peat, limestone, rock phosphate, blood meal, bone meal, compost, humic acid, seaweed extracts, digested proteins, fish meal, feather meal, corn meal, alfalfa meal etc.

Exemplary inorganic fertilizer may be selected from NPK, derivatives of potassium, zinc, phosphate such as those selected from but not limited to potassium fertilizers such as potassium carbonate, potassium chloride (also known as muriate of potash), potassium sulfate, potassium nitrate, sulfate of potash magnesia; zinc fertilizers such as those selected from zinc sulfate, zinc oxide, zinc ammonia complex; phosphate fertilizer such as Di-ammonium phosphate, Monoammonium phosphate, Ammonium polyphosphate, Triple superphosphate or mixtures thereof.

It is an aspect of the present invention that the formulation comprises powdered or granulated starch based super absorbent polymer and herbicide or fungicide or insecticide or bio stimulant or fertilizer or microbial cell or combinations thereof.

It is an aspect of the present invention that the said formulation comprises powdered or granulated starch based super absorbent polymer and a herbicide.

In an embodiment, the herbicide may be those selected from but not limited to: Lipid Synthesis Inhibitors like ACCase Inhibitors, Arylphenoxy propionate e.g. Quizalafop), Cyclohexanedione e.g. Clethodim; Aminoacid synthesis inhibitors like ALS Inhibitors, sulfonylureas e.g. chlorimuron foramsulfuron, halosulfuron, iodosulfuron, nicosulfuron, primisulfuron, prosulfuron, rimsulfuron, thifensulfuron, tribenuron, Imidazolinone e.g. imazamox, imazaquin, imazethapyr, Triazoloyrimidine e.g. flumetsulam, cloransulam, thiencarbazone, EPSP Inhibitors, glyphosate; Growth regulators, specific unknown sites, Phenoxy e.g. 2,4-D, benzoic acid e.g. dicamba, Carboxylic acid e.g. clopyralid, fluroxypyr, Auxin Trasnport, Semicarbazone e.g. diflufenzopyr; Photosynthesis Inhibitors, PS II Inhibitors, Triazine e.g. Atrazine, Simazine, Triazinone e.g. Metribuzin, PS II Inhibitors Nitrile e.g. bromoxynil, Benzothiadiazole e.g. bentazon, Ureas e.g. linuron; Glutamine Synthesis Inhibitors e.g. Glufosinate; Pigment Inhibitors, Diterpene Synthesis Inhibitors, Isoxazolidinone e.g. Clomazone, HPPD Inhibitors, Isoxazole e.g. isoxaflutole, Pyrazolone e.g. topramezone, Triketone e.g. mesotrione, tembotrione; Cell Membrane Disrupters: PPO Inhibitors: Diphenylether e.g. acifluorfen, fomesafen, actofen, N-phenylphthalimide e.g. flumiclorac, flumioxazin, Aryl triazinone e.g. sulfentrazone, carfentrazone, fluthiacet-ethy, Pyrimidinedione e.g. saflufenacil, Photosystem I Electron Diverter: Bipyridilium e.g. paraquat; Seedling Root Growth Inhibitors: Microtubule Inhibitors: Dinitroaniline e.g. ethalfluralin, pendimethalin, trifluralin; Seedling Shoot Growth Inhibitors: Lipid Synthesis Inhibitors (non Accase): Thiocarbamate e.g. butylate, EPIC, Long Chain Fatty Acid Inhibitors: Chloroacetamide e.g. acetochlor, alachlor, metolachlor, dimethenamid, Oxyacetamide e.g. flufenacet, Pyrazole e.g. pyroxasulfone. The herbicide can be further selected from Topramezone, Orthosulfamuron, Pinoxaden, Metamifop, Pyrimisulfan, Tembotrione, Thiencarbazone methyl, Flucetosulfuron, Aminopyralid, Pyrasulfotole, Saflufenacil, Pyroxsulam, Pyroxasulfone, Pyraclonil, Indaziflam, Fenquinotrione, Florpyrauxifen-benzyl, Tiafenacil, Cinmethylin, Lancotrione-Sodium, Bixlozone, Trifludimoxazin, Cyclopyrimorate, Methiozolin, Aminocyclopyrachlor, Metazosulfuron, 1pfencarbazone, Fenoxasulfone, Bicyclopyrone, Triafamone, Halauxifen methyl, Tolpyralate or combinations thereof.

In an embodiment, the composition of the present invention may comprise a herbicide, preferably sulfonylurea herbicide.

In an embodiment, the sulfonylurea herbicide is selected from group comprising of amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, metazosulfuron, methiopyrisulfuron, monosulfuron, nicosulfuron, orthosulfamuron, oxasulfuron, primisulfuron, propyrisulfuron, pyrazosulfuron, rimsulfuron, sulfometuron, sulfosulfuron, trifloxysulfuron, chlorsulfuron, cinosulfuron, ethametsulfuron, iodosulfuron, iofensulfuron, metsulfuron, prosulfuron, thifensulfuron, triasulfuron, tribenuron, triflusulfuron, tritosulfuron, their salts and derivatives thereof.

According to an embodiment of the present invention, the sulfonylurea herbicide is selected from group comprising of bensulfuron, ethoxysulfuron, halosulfuron, nicosulfuron, propyrisulfuron, pyrazosulfuron, rimsulfuron, chlorsulfuron, metsulfuron, tribenuron, their salts and derivatives thereof.

According to an embodiment of the present invention, the sulfonylurea herbicide is pyrazosulfuron, their salts and derivatives thereof.

According to an embodiment of the present invention, the sulfonylurea herbicide is Pyrazosulfuron-ethyl.

In an embodiment, the herbicide may be selected from but not limited to Saathi™.

It is an aspect of the present invention that the formulation comprises powdered or granulated starch based super absorbent polymer and Pyrazosulfuron Ethyl.

It is an aspect of the present invention that the said formulation comprises powdered or granulated polymer starch-g-poly (2-propenamide-co-2-propenoic acid) potassium salt or crosslinked polyacrylic acid potassium salt and Pyrazosulfuron Ethyl.

It is an aspect the present invention to provide a method of preparing a formulation comprising powdered or granulated starch based super absorbent polymer and a bioactive agent.

It is another aspect of the present invention to provide a process for preparing the formulation comprising powdered or granulated starch based super absorbent polymer and a herbicide.

It is another aspect of the present invention to provide a process for preparing the formulation comprising powdered or granulated starch based super absorbent polymer and Pyrazosulfuron Ethyl (PSE).

In another embodiment composition comprises powdered super absorbent polymer of the size 100 plus mesh Powder.

In another embodiment the composition comprises granulated super absorbent polymer of the size 1-20 Mesh granules, preferably 4-18 Mesh size granules, more preferably 8-16 Mesh granules.

In another embodiment the concentration of granulated or free flowable powdered super absorbent polymer in the formulation is in the range from 50%-100%, preferably 90%-100%, preferably 92%-98%, more preferably 95%-98%.

In another embodiment the bioactive agent in the formulation is in the pure technical form and used in an amount in the range from 0.1% to 20%, 0.1%-10%, 0.1%-5%, specifically 0.1%-3%, more specifically, 0.2%-1%, more specifically 0.2%-0.5% by weight of the composition.

In another embodiment the formulation with pure bioactive agent contains other inert agents.

In another embodiment the concentration of inert agent in the formulation is in the range of 0.01% to 10% or 1%-2%, preferably 1.5%-1.8%, more preferably 1.6%-1.79%.

In another embodiment the bioactive agent in the formulation is in the ready-made formulation form.

In another embodiment the concentration of ready-made bioactive formulation is 1%-10% or 1%-5%, preferably 1.5%-4.5%, more preferably 2%-5%.

In another embodiment the pH of the composition is in the range of 2-9, more preferably 5-8, more preferably 6-8.

In another embodiment the bulk density of the composition is in the range of 0.1 g/ml-1 g/ml, preferably 0.2-0.9 g/ml, more preferably 0.5 g/ml-0.8 g/ml.

In a preferred embodiment, the composition of the present invention is in the form of granules or free flowable powder.

In one preferred embodiment the present composition is a dust formulation.

In another preferred embodiment the present composition is a coated granular formulation.

In an embodiment, the composition of the present invention may be applied to plant, root, seed, or seedling by various methods, including, but not limited to dipping the plant, root, seed, or seedling into the superabsorbent polymer composition, a slurry of the superabsorbent polymer, composition, or a paste including the superabsorbent polymer composition of the, invention; mixing another plant growth media with the superabsorbent polymer composition and later planting a plant, root, seed, or seedling into the plant growth media comprising the superabsorbent polymer composition of the invention; or forming a slurry of the superabsorbent polymer composition that is applied directly to the growing substrate.

In preferred embodiment the present composition/formulation is used for coating seeds for improving germination of plant seeds and inhibiting germination of weeds in the fields.

In an embodiment the present invention provides a solid composition of matter comprising powdered or granulated starch based super absorbent polymer and a herbicide preferably Pyrazosulfuron Ethyl which is chemically stable in said composition.

In another aspect the present invention is directed to a process for preparing granulated formulation comprising powdered or granulated super absorbent polymer and a bioactive agent.

The compositions can be prepared from powdered super absorbent polymer having size of 100 plus Mesh and also with granulated super absorbent polymer having size 1-20 Mesh.

In another embodiment the process of preparing the formulation of super absorbent polymer having size of 100 plus Mesh Powder, comprises:
a) Pre-ribbon blending of super absorbent polymer powder with bioactive agent;
b) air jet milling of the mixture;
c) Post ribbon blending of the mixture and
d) Collecting the final product as free flowing powder.

In another embodiment the process of preparing the formulation of super absorbent polymer, where super absorbent polymer is having size 1-20 Mesh granules, preferably 4-18 Mesh granules, more preferably 8-16 Mesh granules, comprises:
a) Adding a super absorbent polymer in a rotating mixer;
b) Adding the bioactive agent;
c) Adding liquid binders in the rotating mixer and drying the mixture at 70° C.-80° C. and;
d) Collecting the coated granules.

The bioactive agent used can be technical or ready formulation. Optionally the process further comprises solid inert/additive in case of technical bioactive.

Further additives such as inert fillers, binding agents, surfactants, dispersing agents and the like may be added to the composition of the present invention.

In an embodiment, the inert fillers and/or binding agents may be selected from but not limited to kaolin, sucrose, lactose, mineral earths and clays such as bentonite, perlite, talc, kaolin, aluminum silicate, diatomaceous earth, attapulgite, clay, barium sulfate, mica, zeolites, calcium carbonate, fused sodium potassium, precipitated silica, precipitated silicates, aluminum silicate, sodium citrate, potassium citrate and magnesium citrate.

Examples of binders useful for the preparation of suitable granular formulation are carbohydrates such as monosaccharides, disaccharides, oligosaccharides and polysaccharides, proteins, lipids, glycolipids, glycoproteins, lipoproteins, and combinations and derivatives thereof.

In another aspect the present invention is directed to a novel method for treating a seed with the granulated formulation comprising powdered super absorbent polymer and a bioactive agent.

In an embodiment the present invention provides a method of coating seeds with the granulated formulation comprising powdered super absorbent polymer and a bioactive agent.

In an embodiment the present invention provides compositions and methods for controlling undesired vegetations/weeds and simultaneously higher germination of seeds.

In another aspect the present invention provides a method for improving delivery of a bioactive ingredient to a plant grown from a seed.

It is another aspect of the present invention directed to a method for improving delivery of a bioactive ingredient to pre-emergent paddy plants or seeds.

In another aspect the present invention provides a method for inhibiting the growth of weeds in the paddy fields.

Surprisingly the present formulation ensures higher germination of paddy seeds and a faster growth as well as prevents a germination of weed seeds around the paddy seed. There is no phytotoxicity observed with present formulation.

In an embodiment the present invention provides a method of cultivation of plant comprising the steps of:
a) Treating pre-germinated plant seeds with a granulated formulation of superabsorbent polymer and pyrazosulfuron-ethyl; and optionally
b) Sowing the treated seeds with broadcast or any other relevant known method.

According to an embodiment of the present invention, a kit comprising stable solid agrochemical composition is provided.

According to an embodiment of the present invention, a kit comprising a composition of granulated formulation of powdered superabsorbent polymer and pyrazosulfuron-ethyl.

In one embodiment of the present invention, the kits may include one or more, including all, components that may be used to prepare the stable solid agrochemical composition. For example, kit may include granulated formulation of powdered superabsorbent polymer and pyrazosulfuron-ethyl optionally with seed package. One or more of the components may already be combined together or ready formulation. In those embodiments where more than two components are provided in a kit, the components may already be combined together and as such are packaged in a single container such as a vial, bottle, can, pouch, bag or canister.

In other embodiments, two or more components of a kit may be packaged separately, that is not pre-formulated. As such, kits may include one or more separate containers such as vials, cans, bottles, pouches, bags or canisters, each container containing a separate component for stable solid agrochemical composition.

In an embodiment of the present invention, the agrochemical composition comprising granulated formulation of powdered superabsorbent polymer and pyrazosulfuron-ethyl is in the form of a kit with single pack or multi pack and an instruction manual instructing an user about administering the composition to a seed or to a plant and the soil.

In an embodiment of the present invention, the agrochemical composition comprising granulated formulation of powdered superabsorbent polymer and pyrazosulfuron-ethyl optionally with nutrients or fertilizers is in the form of a kit with single pack or multi pack.

The following examples are meant to illustrate the present invention. The examples are presented to exemplify the invention and are not to be considered as limiting the scope of the present invention.

### EXAMPLES

### Example 1

Field Trials

Concentration of different ingredient in the formulation prepared.

TABLE 1

| Ingredients | | | | | | | |
|---|---|---|---|---|---|---|---|
| (% w/w) | Formulation-1 | Formulation-2 | Formulation-3 | Formulation-4 | Formulation-5 | Formulation-6 | Formulation-7 |
| Zeba (super | 98 | 95 | | | 98 | 98 | 96 |
| absorbent | | | | | | | |
| polymer) | | | | | | | |
| (100 plus | | | | | | | |
| Mesh) | | | | | | | |
| Zeba | | | 95 | 92 | | | |
| (8-16 Mesh) | | | | | | | |
| Saathi 10 | 2 | 5 | 2 | 5 | | | 2.4 |
| WP | | | | | | | |
| (Pyrazosulfur | | | | | | | |
| on Ethyl | | | | | | | |
| formulation) | | | | | | | |
| Pyrazosulfur | | | | | 0.21 | 0.51 | |
| on Ethyl | | | | | | | |
| technical | | | | | | | |
| 98% | | | | | | | |
| Solid | | | | | 1.79 | 1.49 | 1.6 |
| inert/additive | | | | | | | |
| Liquid binder | | | 3 | 3 | | | |
| Total | 100 | 100 | 100 | 100 | 100 | 100 | 100 |

### Example 2

Physicochemical Analysis data of above tried formulations:

TABLE 2

| | | Formulation-1 | |
|---|---|---|---|
| | | | 14 days |
| | | Initial | AHS |
| Parameters | Specification | (Ambient) | (54° C.) |
| Appearance (Visual) | | Creamy colour | Complies |
| | | free flowing | |
| | | powder | |
| % Loss on Drying (70° C., | Max 8.0 | 4.65 | 4.97 |
| 15 Min) | | | |
| pH (1% in water) | 6.0 to 8.0 | 7.1 | 6.9 |
| Bulk Density (pour) g/ml | 0.5 to 0.8 | 0.52 | 0.54 |
| Water absorption in gm/gm | Min 200 | 252 | 245 |
| of Zeba | | | |
| PSE Active content w/w | | 0.19 | 0.18 |

TABLE 3

| | | Formulation-2 | |
|---|---|---|---|
| | | | 14 days |
| | | Initial | AHS |
| Parameters | Specification | (Ambient) | (54° C.) |
| Appearance (Visual) | | Creamy colour | Complies |
| | | free flowing | |
| | | powder | |
| % Loss on Drying (70° C., | Max 8.0 | 4.11 | 4.16 |
| 15 Min) | | | |
| pH (1% in water) | 6.0 to 8.0 | 7.1 | 6.9 |
| Bulk Density (pour) g/ml | 0.5 to 0.8 | 0.51 | 0.52 |
| Water absorption in gm/gm | Min 200 | 240 | 236 |
| of Zeba | | | |
| PSE Active content w/w | | 0.51 | 0.50 |

TABLE 4

| | | Formulation-3 | |
|---|---|---|---|
| | | | 14 days |
| | | Initial | AHS |
| Parameters | Specification | (Ambient) | (54° C.) |
| Appearance (Visual) | | Greyish to light | Complies |
| | | brown colour | |
| | | free flowing | |
| | | granules | |
| % Loss on Drying (70° C., | Max 8.0 | 3.27 | 3.32 |
| 15 Min) | | | |
| pH (1% in water) | 6.0 to 8.0 | 6.8 | 6.7 |
| Bulk Density (pour) g/ml | 0.5 to 0.8 | 0.68 | 0.68 |
| Water absorption in gm/gm | Min 200 | 277 | 275 |
| of Zeba | | | |
| PSE Active content w/w | | 0.21 | 0.21 |

TABLE 5

| | | Formulation-4 | |
|---|---|---|---|
| | | | 14 days |
| | | Initial | AHS |
| Parameters | Specification | (Ambient) | (54° C.) |
| Appearance (Visual) | | Greyish to light | Complies |
| | | brown colour | |
| | | free flowing | |
| | | granules | |
| % Loss on Drying (70° C., | Max 8.0 | 3.14 | 3.16 |
| 15 Min) | | | |
| pH (1% in water) | 6.0 to 8.0 | 6.9 | 6.7 |
| Bulk Density (pour) g/ml | 0.5 to 0.8 | 0.64 | 0.63 |
| Water absorption in gm/gm | Min 200 | 270 | 262 |
| of Zeba | | | |
| PSE Active content w/w | | 0.49 | 0.49 |

TABLE 6

| | | Formulation-5 | |
|---|---|---|---|
| | | | 14 days |
| | | Initial | AHS |
| Parameters | Specification | (Ambient) | (54° C.) |
| Appearance (Visual) | | Creamy colour | Complies |
| | | free flowing | |
| | | powder | |
| % Loss on Drying (70° C., | Max 8.0 | 4.39 | 4.51 |
| 15 Min) | | | |
| pH (1% in water) | 6.0 to 8.0 | 7.0 | 6.9 |
| Bulk Density (pour) g/ml | 0.5 to 0.8 | 0.56 | 0.58 |
| Water absorption in gm/gm | Min 200 | 227 | 230 |
| of Zeba | | | |
| PSE Active content w/w | | 0.19 | 0.20 |

TABLE 7

| | | Formulation-6 | |
|---|---|---|---|
| | | | 14 days |
| | | Initial | AHS |
| Parameters | Specification | (Ambient) | (54° C.) |
| Appearance (Visual) | | Creamy colour | Complies |
| | | free flowing | |
| | | powder | |
| % Loss on Drying (70° C., | Max 8.0 | 4.25 | 4.22 |
| 15 Min) | | | |
| pH (1% in water) | 6.0 to 8.0 | 3.86 | 3.90 |
| Bulk Density (pour) g/ml | 0.5 to 0.8 | 0.55 | 0.57 |
| Water absorption in gm/gm | Min 200 | 233 | 228 |
| of Zeba | | | |
| PSE Active content w/w | | 0.48 | 0.47 |

TABLE 8

| | | Formulation-7 | |
|---|---|---|---|
| | | | 14 days |
| | | Initial | AHS |
| Parameters | Specification | (Ambient) | (54° C.) |
| Appearance (Visual) | | Creamy colour | Complies |
| | | free flowing | |
| | | powder | |
| % Loss on Drying (70° C., | Max 8.0 | 3.42 | 3.45 |
| 15 Min) | | | |
| pH (1% in water) | 6.0 to 8.0 | 6.9 | 6.8 |
| Bulk Density (pour) g/ml | 0.5 to 0.8 | 0.50 | 0.53 |
| Water absorption in gm/gm | Min 200 | 225 | 219 |
| of Zeba | | | |
| PSE Active content w/w | | 0.24 | 0.23 |

### CONCLUSION

It was observed that stable and effective granulated or free flowable powdered formulation of the said super absorbent polymer and bioactive agent is obtained from the powdered waste of Super absorbent polymer generated during the manufacturing process of the super absorbent polymer.

1. A composition comprising a super absorbent polymer and a bioactive agent.

2. The composition as claimed in claim 1, wherein the superabsorbent polymer is selected from the group consisting of a copolymer of acrylamide and sodium acrylate; hydrolyzed starch-polyacrylonitrile; 2-propenenitrile homopolymer, hydrolyzed, sodium salt or poly(acrylamide co-sodium acrylate) or poly(2-propenamide-co-2-propanoic acid, sodium salt); starch-g-poly(2propenamide-co-2-propanoic acid, mixed sodium and aluminum salts); starch-g-poly(2-propenamide-co-2-propanoic acid, potassium salt); poly(2-propenamide-co-2-propanoic acid, sodium salt); poly-2-propanoic acid, sodium salt; starch-g poly(acrylonitrile) or poly(2-propenamide-co-sodium acrylate);
starch/acrylonitrile copolymer; crosslinked copolymers of acrylamide and sodium acrylate;
acrylamide/sodium polyacrylate crosslinked polymers; anionic polyacrylamide; starch grafted sodium polyacrylates; acrylic acid polymers, sodium salt; crosslinked potassium polyacrylate/polyacrylamide copolymers; sodium polyacrylate; superabsorbent polymer laminates and composites; partial sodium salt of crosslinked polypropenoic acid; potassium polyacrylate, lightly crosslinked; sodium polyacrylate, lightly crosslinked; sodium polyacrylates;
poly(sodiumacrylate) homopolymer; polyacrylamide polymers, carrageenan, agar, alginic acid, guar gums and its derivatives, and gellan gum.

3. The composition as claimed in claim 1, wherein said superabsorbent polymer is starch-g-poly (2-propenamide-co-2-propenoic acid) potassium salt or crosslinked polyacrylic acid potassium salt.

4. The composition as claimed in claim 1, wherein said superabsorbent polymer comprises granules having a size of 100 plus mesh or a size of 1-20 mesh.

5. The composition as claimed in claim 1, wherein 50 to 100% of the super absorbent polymer is granulated or a free flowable powder.

6. The composition as claimed in claim 1, wherein said bioactive agent is selected from an herbicide, a fungicide, an insecticide, a bio stimulant, a fertilizer, a microbial cell, and combinations thereof.

7. The composition as claimed in claim 1, wherein said bioactive agent is in an amount of 0.1% to 20% of the composition.

8. The composition as claimed in claim 1, wherein said bioactive agent is a sulfonylurea herbicide.

9. The composition as claimed in claim 8, wherein said sulfonylurea herbicide is Pyrazosulfuron-ethyl.

10. The composition as claimed in claim 1, wherein said composition is a granulated or free flowable powdered formulation.

11. A formulation comprising a powdered or granulated starch-based super absorbent polymer and pyrazosulfuron ethyl.

12. A process of preparing a formulation comprising a powdered or granulated starch-based super absorbent polymer and a bioactive agent,
(a) wherein the starch-based super absorbent polymer is a 100 plus mesh powder, the method comprises
(i) pre-ribbon blending of the starch-based super absorbent polymer powder with the bioactive agent optionally adding solid inert/additive;
(ii) air jet milling the mixture of i);
(iii) post ribbon blending of the mixture of ii), and
(iv) collecting a final product as free flowing powder,
or
(b) wherein starch-based super absorbent polymer comprises 1-20 mesh granules, the method comprises
(i) adding the starch-based a super absorbent polymer to a rotating mixer;
(ii) adding the bioactive agent optionally adding solid inert/additive;
(iii) adding liquid binders to the rotating mixer and drying the mixture at 70° C.-80° C. and;
(iv) collecting coated granules from the rotting mixture.

13. A method for controlling growth of weeds comprising contacting a seed or a plant with the composition of claim 1.

14. The method as claimed in claim 13, wherein said composition is applied in paddy fields.

15. A method of cultivating a plant comprising: treating pre-germinated plant seeds with a granulated formulation of superabsorbent polymer and pyrazosulfuron-ethyl; and sowing the treated seeds.
